(19) United States
(12) Patent Application Publication
(10) Pub. No.: US 2020/0164472 A1
(43) Pub. Date: May 28, 2020

(54) WIRE FOR WELDING DIFFERENT TYPES OF MATERIALS AND METHOD OF MANUFACTURING THE SAME

(71) Applicant: NIPPON WELDING ROD CO., LTD., Tokyo (JP)

(72) Inventors: Teiichiro SAITO, Tokyo (JP); Hiroshi KOYAMA, Tokyo (JP); Yukio AGATA, Tokyo (JP); Masaya YOSHIDA, Tokyo (JP); Norihito OGAWA, Tokyo (JP)

(21) Appl. No.: 16/635,313

(22) PCT Filed: Aug. 2, 2017
(86) PCT No.: PCT/JP2017/027961

§ 371 Date: Jan. 30, 2020

(51) Int. Cl. B23K 35/02; B23K 35/40; B23K 26/211; B23K 35/28

(52) U.S. Cl. CPC B23K 35/0266; B23K 35/406; B23K 2035/408; B23K 35/282; B23K 35/286; B23K 26/211

(57) ABSTRACT

A wire for welding different types of materials and a method of manufacturing the same that enable suppressing the occurrence of non-uniform filling with flux while reducing the flux filling rate are provided. A conductive core wire material and a metal outer skin material are made of aluminum or aluminum alloy. A flux paste is applied to the surface of the conductive core wire material to form a coated conductive core wire material including a coating layer, or a flux paste is applied to the inner surface of the metal outer skin material to form a coated metal outer skin material including a coating layer. A tubular metal outer skin material is formed. The conductive core wire is disposed inside to form a wire for drawing. The flux is disposed as distributed over the longitudinal and circumferential directions of the wire after a solvent in the coating layer is removed.

### TECHNICAL FIELD

The present invention relates to a wire for welding different types of materials of a Fe-based material and an Al-based material to each other, and to a method of manufacturing the same.

### BACKGROUND ART

Japanese Patent No. 5689492 (Patent Document 1) discloses a filler material for joining different materials (wire for welding different types of materials) for joining an aluminum material or an aluminum alloy material and a steel material to each other, the filler material enhancing the joint strength, suppressing a crack in the joint portion, and further making it less likely that a break is caused during wire drawing. In the wire for welding different types of materials according to the related art, the skin material contains at least 1.0 to 6.0 mass percent of Si, 0.01 to 0.30 mass percent of Ti, and 0.01 to 0.30 mass percent of Zr with the remainder consisting of aluminum and an aluminum alloy as unavoidable impurities, and a metal outer skin in a tubular shape is filled with flux in a powder form at a filling rate of 2.0 to 20.0 mass percent with respect to the total mass of the wire.

Japanese Patent No. 4256886 (Patent Document 2) discloses a flux-cored wire for joining different materials such as a steel material and an aluminum alloy material, the flux-cored wire using flux having a fluoride composition containing 0.1 to 15 mass percent of AlF₃ with respect to the total mass of the flux-cored wire and not containing chloride, and the flux cored wire being filled with 0.3 to 20 mass percent of the flux with respect to the total mass of the flux-cored wire. The flux-cored wire is manufactured by filling a metal outer skin in a tubular shape with the flux in a powder form. Paragraph [0066] of the document contains the wording “metal powder was added in all the cases where the amount of the flux in the flux-cored wire was 1 mass percent or less with respect to the total weight of the flux-cored wire. Aluminum alloy powder (particle size: 150 μm) with a composition corresponding to A4047, as with the outer skin, was used as the metal powder for all the cases. The metal powder was added in an amount of twenty mass percent with respect to the total weight of the flux-cored wire.” The document describes a method of adding flux for occasions when the amount of the flux has been reduced, in which metal powder is added to the flux to increase the apparent amount of the flux to enable filling with the flux.

There has recently been a request to join a Fe-based material and an Al-based material to each other with a low current. It has been found that, in order to achieve such a request, preferable welding results are obtained by joining the Fe-based material in a brazed state while preventing excessive penetration of the Al-based material (Non-Patent Document 1).

Further, Japanese Patent No. 4263879 (Patent Document 3) discloses a wire for welding in which flux is provided between a metal outer skin in a tubular shape and a conductive core wire, the wire for welding having a flux filling rate of 6.5 to 30%, preferably 15.5 to 19.5%. Japanese Patent No. 5444293 (Patent Document 4) discloses a method of manufacturing the wire for welding. In these conventional technologies, the wire diameter of the conductive core wire is smaller than the inside diameter of the metal outer skin in a tubular shape, and the metal outer skin in a tubular shape is filled with the flux in a powder form as in the conventional technologies described in Patent Documents 1 and 2.

### RELATED-ART DOCUMENT

### Patent Document

Patent Document 1: Japanese Patent No. 5689492

Patent Document 2: Japanese Patent No. 4256886

Patent Document 3: Japanese Patent No. 4263879

Patent Document 4: Japanese Patent No. 5444293

### Non-Patent Document

Non-Patent Document 1: Technical Paper: Nippon Steel Technical Report No. 393 (2012) “Dissimilar Metal Joining Technologies for Steel Sheet and Aluminum Alloy Sheet in Auto Body”, Joint Research Center, Steel Research Laboratories, Nippon Steel & Sumitomo Metal Corporation

### SUMMARY OF INVENTION

### Technical Problem

The flux for the wires for welding according to the related art is used to stabilize an arc and shield a molten pool from the atmosphere. Therefore, it is necessary to fill the metal outer skin with a considerably large amount of the flux in order to achieve such goals of the flux. However, Patent Document 1 does not disclose anything about the relationship between the flux filling rate and the penetration. This is based on the fact that Patent Document 1 only discloses that an effect can be obtained in examples in which the flux filling rate with respect to the total mass of the wire is 5 mass percent, and that the document 1 does not disclose that an effect can be obtained in the entire range of the flux filling rate (2 to 20%) specified in the claims.

As also described in Patent Document 2, the amount of flux to be used in conventional welding is preferably small in order to join the Fe-based material in a brazed state while preventing excessive penetration of the Al-based material when welding is performed with a low current. In high-speed welding using laser, in particular, unmelted flux occasionally remains after welding if the amount of the flux is so large. Thus, it is necessary to reduce the amount of the flux also from this point. Patent Document 2 indicates that a metal outer skin can be filled with the flux by increasing the apparent amount of the flux by adding metal powder if the amount of the flux is 1 mass percent or less with respect to the total weight of the flux-cored wire. When the present inventors actually performed a verification test, however, it was found that it was necessary to increase the apparent amount of the flux by adding metal powder to the flux in a powder form in order to suppress the occurrence of non-uniform filling with the flux also when a metal outer skin in a tubular shape is filled with about 5 mass percent of the flux which is higher than 1 mass percent.

The inventors attempted to reduce the flux filling rate by providing flux between the metal outer skin in a tubular shape and the conductive core wire as in the conventional technologies described in Patent Documents 3 and 4. Even if such conventional technologies are used, however, the flux is occasionally locally provided between the metal outer skin in a tubular shape and the conductive core wire when the flux filling rate is reduced, and the flux cannot be provided without significant non-uniform distribution through the circumferential direction of the wire. This is because the flux filling rate is assumed to be high in the conventional technologies described in Patent Documents 3 and 4 compared to the present invention.

It is an object of the present invention to provide a method of manufacturing a wire for welding different types of materials that enables suppressing the occurrence of non-uniform filling with flux while reducing the flux filling rate.

It is another object of the present invention to provide a wire for welding different types of materials that allows a Fe-based material and an Al-based material to be joined to each other with a low current and that requires a small amount of flux for filling.

### Solution To Problem

The present invention provides a method of manufacturing a wire for welding different types of materials of an Fe-based material and an Al-based material to each other, the wire including a conductive core wire made of aluminum or an aluminum alloy and disposed in a tubular metal outer skin made of aluminum or an aluminum alloy, and the wire including flux provided between the metal outer skin and the conductive core wire and having at least a function of removing an oxidized film from a surface of a material to be welded. The wire has a flux filling rate of 4.9 mass percent or less with respect to the total mass of the wire.

In a first manufacturing method according to the present invention, a coated conductive core wire material including a coating layer is formed by applying a flux paste, which is obtained by kneading a material of the flux and a solvent with each other, to a surface of a conductive core wire material for forming the conductive core wire. Next, a wire for drawing is formed by forming a tubular metal outer skin material for forming the tubular metal outer skin outside the coated conductive core wire material so that the coated conductive core wire material is centrally located in the tubular skin material. Then, drawing work is performed until the wire for drawing has a predetermined outside diameter.

In a second manufacturing method according to the present invention, meanwhile, a coated metal outer skin material including a coating layer is formed by applying a flux paste, which is obtained by kneading a material of the flux and a solvent with each other, to an inner surface of a metal outer skin material having an arcuate cross-sectional shape taken orthogonally to a longitudinal direction thereof. Next, a wire for drawing is formed by forming a tubular metal outer skin material outside a conductive core wire material for forming the conductive core wire by shaping the coated metal outer skin material with the conductive core wire material disposed inside the coated metal outer skin material. Then, drawing work is performed until the wire for drawing has a predetermined outside diameter.

In the manufacturing method according to the present invention, a coated conductive core wire material including a coating layer is formed by applying a flux paste to the surface of a conductive core wire material, or a coated metal outer skin material including a coating layer is formed by applying a flux paste to the inner surface of a metal outer skin material, and thereafter a tubular metal outer skin material is formed to form a wire for drawing. As a result of the coating layer being formed over the circumferential direction of the wire in this manner, the flux is disposed as distributed over the longitudinal direction and the circumferential direction of the wire after a solvent in the coating layer is removed, even if the flux filling rate is low.

With the manufacturing method according to the present invention, in either case, a wire for welding different types of materials in which the flux is not significantly locally non-uniform can be manufactured even if the flux filling rate is low.

Preferably, the tubular metal outer skin material is formed after the coating layer is dried to such a degree that a part of the solvent remains. In this manner, the thickness of the coating layer is not significantly non-uniform.

The wire for welding different types of materials for welding a Fe-based material and an Al-based material to each other according to the present invention includes a conductive core wire made of aluminum or an aluminum alloy and disposed in a tubular metal outer skin made of aluminum or an aluminum alloy. The wire also includes flux provided between the metal outer skin and the conductive core wire and having at least a function of removing an oxidized film from a surface of the material to be welded. The wire has a low flux filling rate of 4.9 mass percent or less with respect to the total mass of the wire for welding different types of materials. In the present invention, the flux between the metal outer skin and the conductive core wire is provided as a dried coating layer.

The term “dried coating layer” as used herein refers to “flux powder formed by drying a coating layer formed by applying a flux paste obtained by kneading the material of the flux and a solvent with each other, the flux powder being provided at a portion at which the coating layer has been provided”. If the flux is provided in the form of a dried coating layer, a small amount of the flux can be disposed without significant non-uniformities over the circumferential direction of the wire.

With the wire for welding different types of materials according to the present invention, the flux can be stably supplied to the welded portion during welding, even if the amount of the flux is reduced. As a result, with the wire for welding different types of materials according to the present invention, an arc is stabilized even in a low-current range, and therefore the Fe-based material can be joined in a brazed state while preventing excessive penetration of the Al-based material.

The thickness of the coating layer is determined according to the amount of the flux. If the flux filling rate is 0.2 to 4.9 mass percent, the coating layer has a maximum thickness of 200 μm or less.

The outside diameter of the wire for welding different types of materials is preferably about 1.0 mm to 2.0 mm, as with the outside diameter of wires that can be used with welding machines currently used in the market.

If the wire is used for MIG welding, the Fe-based material is carbon steel or stainless steel, and the Al-based material is an aluminum alloy, the conductive core wire is preferably made of aluminum or an aluminum alloy having a solidus temperature that is lower than that of the metal outer skin. This is because a stable arc is obtained with droplet transfer in which thin and long liquid columns, such as those seen when a solid wire is welded using an inert shield gas, are not generated when the conductive core wire having a solidus temperature that is lower than that of the metal outer skin is used.

If the wire for welding different types of materials according to the present invention is used for MIG welding, preferably, the wire for welding different types of materials has an outside diameter of 1.0 mm to 1.6 mm, and the wire has a flux filling rate of 0.2 to 1.8 mass percent with respect to the total mass of the wire for welding different types of materials. If the flux filling rate is in this range, an arc is stabilized even in a low-current range in the MIG welding, and therefore the Fe-based material can be joined in a brazed state while preventing excessive penetration of the Al-based material.

If the wire is used for MIG welding, and if the wire has a flux filling rate of 1.0 to 1.8 mass percent with respect to the total mass of the wire for welding different types of materials, the arc stability is further increased, spatter is accordingly decreased, and good beads are formed.

If the wire for welding different types of materials according to the present invention is used for laser welding, preferably, the wire for welding different types of materials has an outside diameter of 1.0 mm to 2.0 mm, and the wire has a flux filling rate of 1.0 to 4.9 mass percent with respect to the total mass of the wire for welding different types of materials. If the flux filling rate is in this range, unmelted flux does not remain in the laser welding, the molten state is stabilized, good beads are formed, and the Fe-based material can be joined in a brazed state to the Al-based material while preventing excessive penetration of the Al-based material.

If the wire is used for laser welding, and if the wire has a flux filling rate of 1.3 to 4.4 mass percent with respect to the total mass of the wire for welding different types of materials, the molten state is further stabilized, the conformability is further increased, and good beads are formed.

For the purpose of removing an oxidized film, the flux occasionally contains a KAlF-based metal fluoride as a main component, and one or more kinds of metal fluorides such as CsAlF₄, CsF, KF, NaF, LiF, CeF, and AlF₃ added thereto. The flux may also contain one or more kinds of metal powder of Al, Si, Cu, Zn, and Mn further added thereto. The flux may not contain one or more kinds of metal fluorides such as CsAlF₄, CsF, KF, NaF, LiF, CeF, and AlF₃ added thereto.

### BRIEF DESCRIPTION OF DRAWINGS

FIG. 1A schematically illustrates a device configured to manufacture a wire for drawing, and FIG. 1B is an enlarged cross-sectional view of a part of the device.

FIG. 2A is a photograph illustrating an example of the cross section of a wire for welding different types of materials, the wire being manufactured by drawing the wire for drawing manufactured using the device in FIG. 1A, and FIG. 2B is a photograph illustrating an example of the cross section of a wire for welding different types of materials, the wire being manufactured by drawing a wire for drawing manufactured by filling the space between a metal outer skin and a conductive core wire with powder flux using a manufacturing method according to the related art described in Patent Document 4.

FIG. 3A schematically illustrates a different device configured to manufacture a wire for drawing, and FIG. 3B is an enlarged cross-sectional view of a part of the device.

FIG. 4 illustrates a simulated cross-sectional view of the wire for welding different types of materials according to the present embodiment.

FIG. 5 illustrates Table 1 which indicates the structure, the types of the metal outer skin and the conductive core wire, the solidus temperature difference, the flux filling rate, the flux supply method, and the type of the flux contained for wires according to examples and comparative examples.

FIG. 6 illustrates Table 2 which indicates the evaluation results of evaluation tests performed on the wires for welding different types of materials according to the examples and the comparative examples.

FIGS. 7A to 7C illustrate the joint shapes of test pieces used in a tensile test.

### DESCRIPTION OF EMBODIMENTS

### [Description of Manufacturing Method]

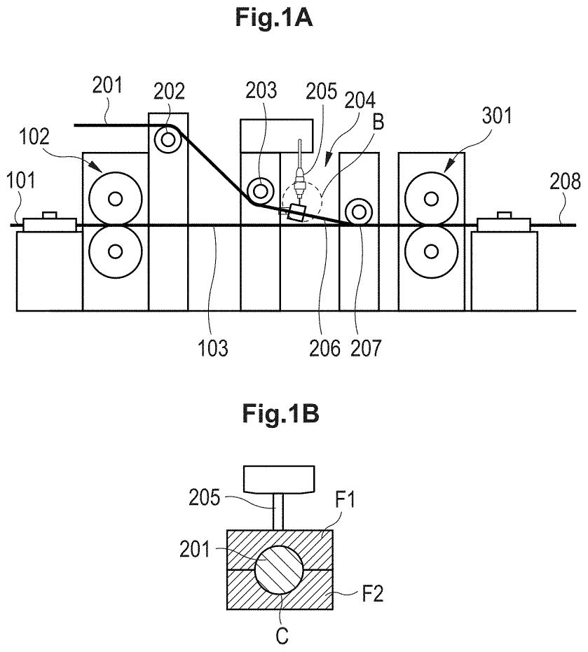

A method of manufacturing a wire for welding different types of materials according to an embodiment of the present invention and a wire for welding different types of materials manufactured by the method will be described in detail below. FIG. 1A schematically illustrates a part of a manufacturing apparatus configured to implement a first manufacturing method according to the present invention, and FIG. 1B is an enlarged cross-sectional view schematically illustrating a part B surrounded by a circular mark in FIG. 1A.

A method of manufacturing a wire for welding different types of materials including a dried coating layer of flux (a first method according to an embodiment of the present invention) will be described. First, an elongated metal outer skin material 101 made of aluminum or an aluminum alloy and fed from a metal plate feed coil (not illustrated) is shaped by a primary shaping roller device 102 to have an arcuate cross section in the width direction. A conductive core wire material 201 made of aluminum or an aluminum alloy and fed from a wire feed coil (not illustrated) is supplied to a coating device 204 via guide rollers 202 and 203. In the coating device 204, as illustrated in FIG. 1B, a flux paste is applied to the conductive core wire material 201 which passes between a pair of felts F1 and F2. The flux paste is a liquid mixture of a powder flux material and a solvent [e.g. ethyl alcohol (C₂H₅OH)]. The flux paste is supplied from an applicator 205 to the felts F1 and F2. The flux paste is applied to the entire outer peripheral surface of the conductive core wire material 201 which has passed between the felts F1 and F2 to form a coating layer C. Before a coated conductive core wire material 206 including the coating layer C reaches a guide roller 207, the coating layer C is dried by a drying device (not illustrated) to such a degree that the solvent remains in a part of the coating layer C (i.e. to such a degree that the flux does not fall off). In this state, the coating layer does not fall off from the conductive core wire material 201. In the present embodiment, the coated conductive core wire material 206 is formed using the applicator 205. However, the coating layer may be formed by immersing the conductive core wire material 201 in an immersion bath in which the flux paste is stored and causing the conductive core wire material 201 to pass through the immersion bath.

Next, the coated conductive core wire material 206 is inserted into a region surrounded by a metal outer skin material 103 in an arcuate shape to merge the coated conductive core wire material 206 and the metal outer skin material 103 with each other. The materials and dimensions of the metal outer skin material 101 and the conductive core wire material 201 are selected such that the proportion of the cross-sectional area of the conductive core wire to the cross-sectional area of the wire obtained after the wire drawing process is 10 to 40% if the final wire diameter is 1.2 mm which is the standard dimension. Next, the metal outer skin material 103 is shaped by a secondary shaping roller device 301 to reduce the dimension of the gap at the seam of the metal outer skin material 103 to form a wire for drawing 208 in which the outer periphery of the coated conductive core wire material 206 is surrounded by the metal outer skin material in a tubular shape. After that, the wire for drawing 208 is subjected to wiring drawing performed using a known wire drawing device. When the wire drawing is performed, there remains little solvent in the coating layer, and the coating layer has been turned into a dried coating layer. In the drawing work, the cross-sectional area of the wire is decreased stepwise to a predetermined wire diameter with the flux powder in the dried coating layer pressurized to be densified, and thereafter the wire is dried to be completed. The above manufacturing processes are dividable as appropriate.

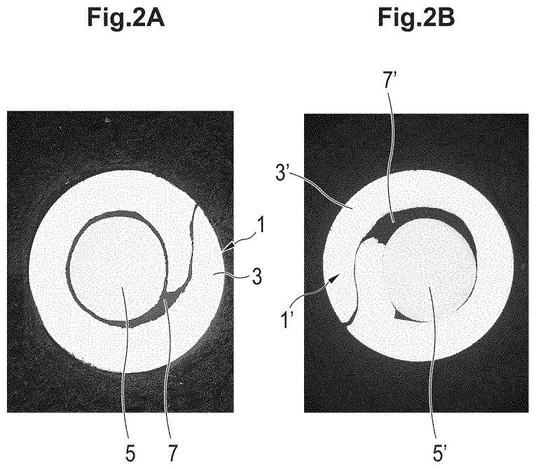

FIG. 2A is a photograph illustrating an example of the cross section of the wire for welding different types of materials manufactured by drawing the wire for drawing manufactured using the device in FIG. 1A. FIG. 2B is a photograph illustrating an example of the cross section of a wire for welding different types of materials manufactured by drawing a wire for drawing manufactured by filling the space between a metal outer skin and a conductive core wire with powder flux using the manufacturing method according to the related art described in Patent Document 4. In both FIGS. 2A and 2B, the flux filling rate is about 4.7 mass percent with respect to the total mass of the wire. The wire for welding different types of materials 1 manufactured according to the present embodiment illustrated in FIG. 2A includes the flux layer 7 constituted of a dried coating layer and provided between a metal outer skin 3 and a conductive core wire 5. In FIG. 2B, portions that are similar to the components in FIG. 2A are given symbols used in FIG. 2A with a dash. As seen from the cross section of the wire manufactured using the method according to the related art in FIG. 2B, there are local non-uniformities in the amount of a flux layer 7′ provided between a metal outer skin 3′ in a tubular shape and a conductive core wire 5′ when the flux filling rate is low. When the flux layer 7 is provided in the form of a dried coating layer as in the wire illustrated in FIG. 2A and manufactured by the method according to the present embodiment, in contrast, a small amount of flux can be disposed without significant non-uniformities over the circumferential direction of the wire.

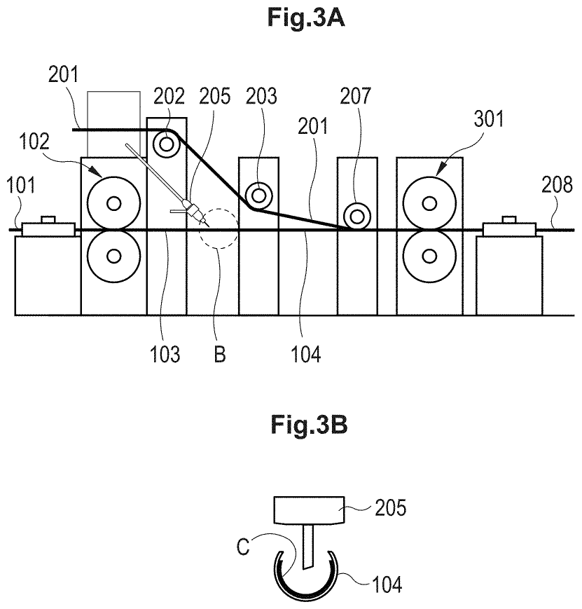

FIG. 3A schematically illustrates apart of a manufacturing apparatus configured to implement a second manufacturing method according to the present invention, and FIG. 3B is an enlarged cross-sectional view schematically illustrating a part B surrounded by a circular mark in FIG. 3A. In FIGS. 3A and 3B, members that are the same as those illustrated in FIGS. 1A and 1B are denoted by the same reference numerals as those used in FIGS. 1A and 1B. In the manufacturing apparatus in FIG. 3A, in comparison to the manufacturing apparatus in FIG. 1A, a coated metal outer skin material 104 including a coating layer C is formed by applying a flux paste, which is obtained by kneading a flux material and a solvent, to the inner surface of the metal outer skin material 103 with an arcuate cross-sectional shape taken orthogonally to the longitudinal direction thereof. Next, the coated metal outer skin material 104 is shaped by a secondary shaping roller device 301 with the conductive core wire material 201 for forming a conductive core wire disposed inside the coated metal outer skin material 104 to form the metal outer skin material in a tubular shape outside the conductive core wire material to form a wire for drawing 208. Also in the second manufacturing method, the coating layer C is dried by a drying device (not illustrated) to such a degree that the solvent remains in a part of the coating layer C, that is, to such a degree that the flux does not fall off from the inner surface of the metal outer skin material, before the coating layer C enters the secondary shaping roller device 301. Also when the second manufacturing method is used, as with the first manufacturing method, the flux layer 7 is provided in the form of a dried coating layer, and therefore a small amount of flux can be disposed without significant non-uniformities over the circumferential direction of the wire.

[Wire for Welding Different Types of Materials According to Present Embodiment]

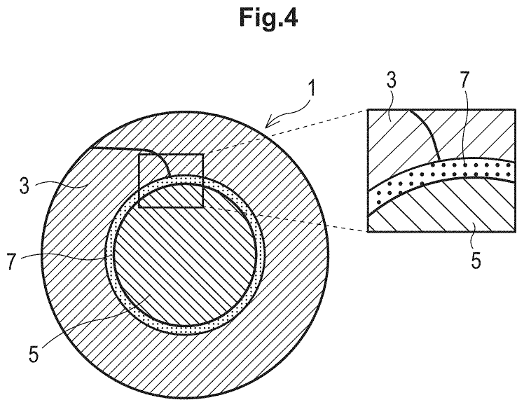

The wire for welding different types of materials according to the present embodiment manufactured by the manufacturing method described above is a wire for welding different types of materials for welding a Fe-based material and an Al-based material to each other. In the wire for welding different types of materials 1 according to the present embodiment, as illustrated in the simulated cross section (a cross section taken in the direction orthogonal to the longitudinal direction of the wire) illustrated in FIG. 4, the conductive core wire 5 which is made of aluminum or an aluminum alloy is disposed in the metal outer skin 3 in a tubular shape which is made of aluminum or an aluminum alloy, and the flux layer 7 containing metal powder as an alloy element of molten metal or a metal fluoride flux layer 7 not containing such metal powder is provided in the form of a dried coating layer between the metal outer skin 3 and the conductive core wire 5, the flux layer 7 having at least a function of removing an oxidized film from the surface of the material to be welded. The wire for welding different types of materials 1 according to the present embodiment has an outside diameter of 1.0 to 2.0 mm. This dimension is a typical wire diameter of a wire for welding for use with the existing welding machines. The flux filling rate is 0.2 to 4.9 mass percent with respect to the total mass of the wire for welding different types of materials 1.

If a small amount of the flux 7 with fine particles and low flowability such as the metal fluoride flux used for the wire 1 according to the present embodiment is surrounded in a metal outer skin as in the wire for welding according to the related art described in Patent Document 1, the small amount of flux cannot be provided without significant non-uniform distribution in the longitudinal direction and the circumferential direction of the wire. In contrast, in the present embodiment, a small amount of the flux is provided in the form of a dried coating layer inside the wire 1, and thus the flux layer 7 is provided between the metal outer skin 3 in a tubular shape and the conductive core wire 5 without significant non-uniform distribution in the longitudinal direction and the circumferential direction.

### (Type of Flux)

To join aluminum or an aluminum alloy, it is necessary to remove an aluminum oxidized film on the surface of the base material since such a film hinders the flow and spread of the molten metal. Therefore, the oxidized films on the surface of the base materials are removed using the flux. In particular, alkali metal fluoride flux acts to dissolve the aluminum oxidized film on the surface of the base material with molten alkali to activate the surface and make the surface easily wetted with the molten metal.

Examples of the flux for use according to the present embodiment include flux containing one or more kinds of metal-based fluorides such as KAlF-based metal fluoride, CsAlF₄, AlF₃, CsF, NaF, KF, LiF, and CeF etc. and substances obtained by adding metal powder of one or more kinds of Al, Si, Cu, Zn, and Mn to such flux.

In a particularly preferable embodiment, flux containing KAlF-based metal fluoride as a main component and one or more kinds of metal fluorides such as AlF₃, CsF, LiF, NaF, and CeF etc. is preferably used as flux for MIG welding, for the purpose of providing high wettability and reducing blowholes. Meanwhile, flux containing a KAlF-based metal fluoride as a main component, CsAlF₄ as an essential component, and one or more kinds of metal fluorides such as NaF and KF etc. added thereto is preferably used as flux for laser welding.

### EXAMPLES AND COMPARATIVE EXAMPLES

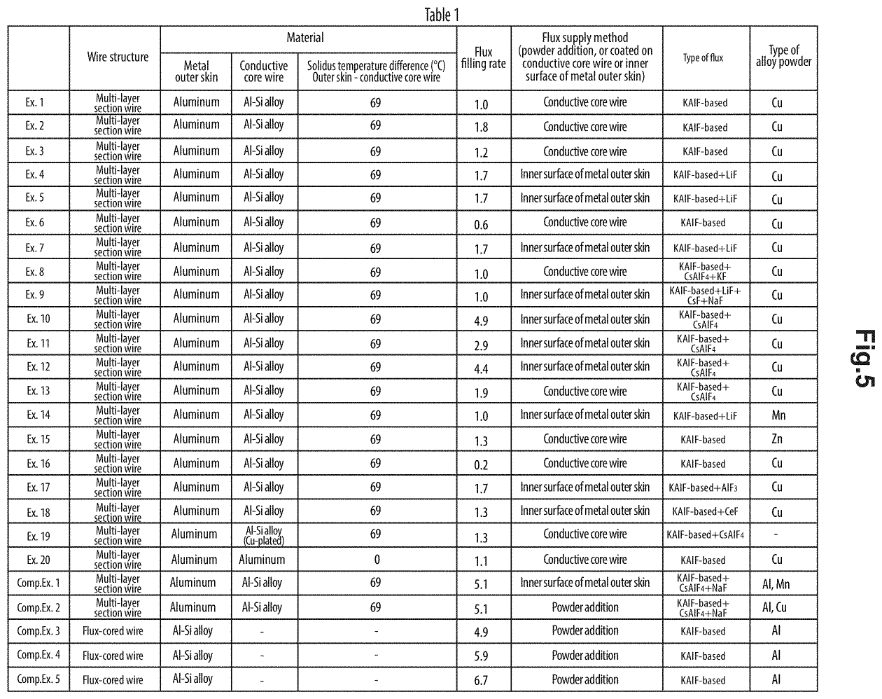

The results of welding tests performed using wires for welding different types of materials according to examples and comparative examples of the present invention will be described below. Table 1 illustrated in FIG. 5 indicates the structure, the types of the metal outer skin and the conductive core wire, the solidus temperature difference, the flux filling rate, the flux supply method, and the type of the flux contained for wires for welding different types of materials according to Examples 1 to 20 of the present invention including a dried coating layer as a flux layer. Table 1 also indicates the structure, the types of the metal outer skin and the conductive core wire, the solidus temperature difference, the flux filling rate, the flux supply method, and the type of the flux contained for Comparative Example 1 in which the flux filling rate is increased using a dried coating layer, Comparative Example 2 in which flux in a powder form is charged without using a dried coating layer, Comparative Examples 3 to 5 for flux-cored wires, for comparison and verification of the effect of the present invention. In Examples 1 to 20 and Comparative Example 1 described below, the flux filling rate was varied by varying the dimension of a slight clearance formed between the metal outer skin 3 and the conductive core wire 5 by setting the outside diameter of the wire for welding different types of materials 1 to 1.2 mm or 1.6 mm, varying the inside diameter of the metal outer skin 3 and the outside diameter of the conductive core wire 5, and charging the flux as the dried coating layer. In Comparative Examples 3 to 5, as in the wires described in Patent Documents 1 and 2, only flux in a powder form was charged inside the metal outer skin without using the conductive core wire.

In Table 1 illustrated in FIG. 5, each row indicates the structure, the types of the metal outer skin and the conductive core wire, the solidus temperature difference, the flux filling rate, the flux supply method, and the type of the flux contained for the wires for welding different types of materials according to Examples 1 to 20 and Comparative Examples 1 to 5. In the wires for welding different types of materials according to Examples 1 to 19, aluminum was used for the metal outer skin and an Al—Si-based alloy was used for the conductive core wire so that the solidus temperature of the conductive core wire was lower than that of the metal outer skin. In Example 20, aluminum was used for the metal outer skin and the conductive core wire, and the flux was provided as a dried coating layer between the metal outer skin and the conductive core wire. In Example 19, a Cu-plated core wire was used for the conductive core wire, and therefore no metal powder was added to the flux.

All the fluxes used for the wires for welding different types of materials according Examples 1 to 20 contained one or more kinds of metal fluoride flux such as KA1F-based metal fluoride, CsAlF₄, AlF₃, CsF, NaF, KF, LiF, and CeF etc., with one or more kinds of metal powder of Al, Si, Cu, Mn, and Zn added thereto or with no such metal powder added thereto. In the wires for welding according to Examples 1 to 18, Si was contained as a chemical component of the conductive core wire, at least one kind of three alloy elements of Cu, Mn, and Zn was contained in the flux, and the remainder consisted of Al and unavoidable impurities.

### (Chemical Components of Wire for Welding)

Chemical components contained in the wire for welding will be described below.

Si: Si forms a thin FeSiAl-based layer, when joining aluminum or an aluminum alloy and a steel material to each other, at the joint interface on the steel material side, and suppresses mutual diffusion of Fe and Al. Therefore, Si effectively suppresses generation of a fragile intermetallic compound (IMC) made of FeAl, and significantly contributes to improving the joint strength. Si also improves wettability, and improves the conformability and shape of the beads. It should be noted, however, that Si should be contained in an adequate amount since a sufficient effect cannot be obtained if the amount of Si added is too small, and the form of the FeSiAl-based layer at the joint interface on the steel material side is varied to reduce the effect in suppressing mutual diffusion of Fe and Al, which permits growth of a fragile FeAl-based IMC to lower the joint strength, if the amount of Si added is too large.

Cu: Cu forms a solid solution in a matrix, and contributes to improving the strength. Cu also contributes to improving the strength through precipitation strengthening if Cu is added in an amount exceeding the limit of solid solution formation. It should be noted, however, that Cu should be contained in an adequate amount since a sufficient effect cannot be obtained if the amount of Cu added is too small, and the sensitivity to a weld crack is significantly enhanced, the tenacity is lowered because of an increase in the CuAl-based intermetallic compound and further, when joining aluminum or an aluminum alloy and a steel material to each other, generation of an FeAl-based intermetallic compound at the joint interface on the steel material side is promoted if the amount of Cu added is too large.

Mn: Mn forms a solid solution in a matrix, and contributes to improving the strength. It should be noted, however, that Mn should be contained in an adequate amount since the strength and the tenacity are lowered because of coarsening of crystal grains and generation of a coarse intermetallic compound if the amount of Mn added is too large.

Zn: Zn improves the conformability of the beads and further, when joining aluminum or an aluminum alloy and a steel material to each other, contributes to suppressing generation of a FeAl-based IMC at the joint interface on the steel material side and improves the joint strength. However, Zn should be contained in an adequate amount since blowholes in welded metal are increased, the joint strength is lowered, and the amount of fume generated during welding is increased if the amount of Zn added is too large.

### (Evaluation Results)

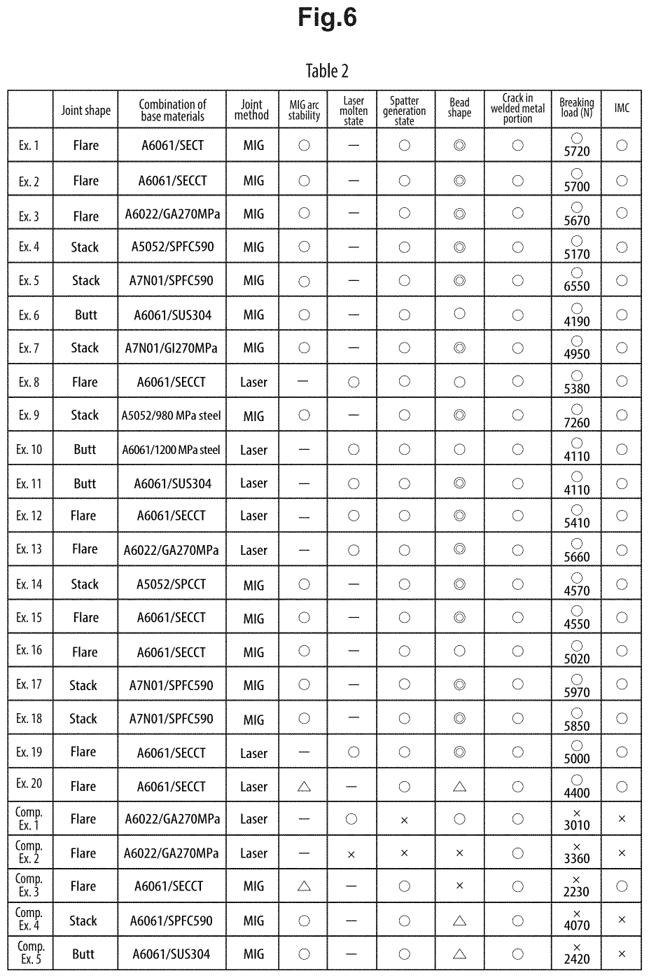

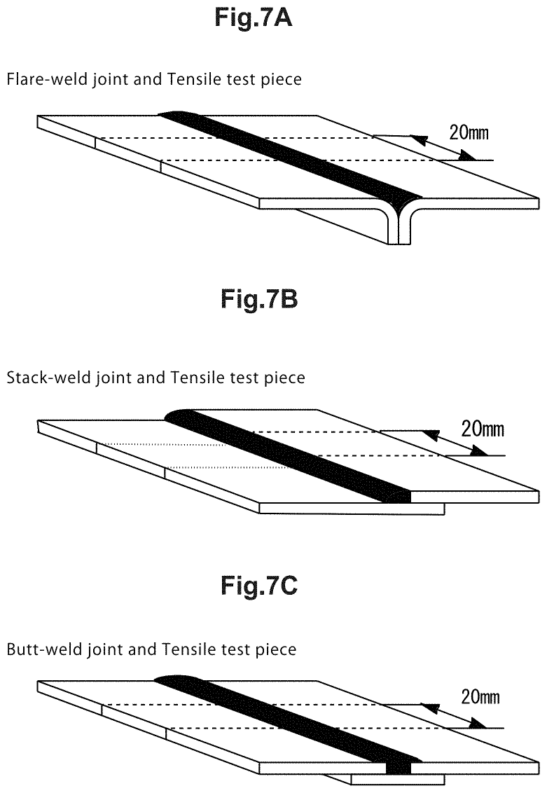

Table 2 illustrated in FIG. 6 indicates the evaluation results of evaluation tests performed on the wires for welding different types of materials according to Examples 1 to 20 and Comparative Examples 1 to 5 indicated in Table 1. In the evaluation tests, the arc stability in MIG welding or the molten state in laser welding, the spatter generation state, the bead shape for the fabricated test piece, the presence or absence of a crack in the welded metal portion, the breaking load in a tensile test, and the thickness of an intermetallic compound (IMC) layer at the interface on the steel material side (interface on the carbon steel or stainless steel side) for a case where the wire was fabricated by one-pass MIG welding or laser welding were checked according to the differences in the joint shape, combination of base materials (combination of the aluminum alloy and the carbon steel or stainless steel), and the joint method. A test piece [FIG. 7A] of a flare-weld joint, a test piece [FIG. 7B] of a stack-weld joint, and a test piece [FIG. 7C] of a butt-weld joint, fabricated through one-pass welding, were used as joint test pieces.

The test piece of the flare-weld joint in FIG. 7A was a combination of an aluminum alloy A6061 (JIS H 4000) and an electrogalvanized steel plate (JIS G 3313, SECCT) or of an aluminum alloy A6022 and an alloyed hot-dip galvanized steel plate (GA270 MPa). The aluminum alloy had a plate thickness of 1.2 or 1.5 mm, and the galvanized steel plate had a plate thickness of 0.8 mm.

The test piece of the stack-weld joint in FIG. 7B was a combination of an aluminum alloy A5052, A6061, or A7N01 (JIS H 4000) and a carbon steel plate (JIS G 3141, SPCCT and JIS G 3135, SPFC590) or a hot-dip galvanized steel plate (GI270MPa) and a 980 MPa-class steel plate. The aluminum alloy had a plate thickness of 1.2 or 2.0 mm, and the carbon steel plate had a plate thickness of 0.8 or 1.0 mm.

The test piece of the butt-weld joint illustrated in FIG. 7C was a combination of an aluminum alloy A6061 (JIS H 4000) and a 1200 MPa-class steel plate or SUS 304 (JIS G 4305). The aluminum alloy had a plate thickness of 1.0 mm, and the 1200 MPa-class steel plate and SUS 304 had a plate thickness of 1.6 mm. The back plate was a carbon steel plate (JIS G 3141, SPCCT), and had a plate thickness of 1.2 mm.

### (Welding Conditions)

The MIG welding was performed using a wire for welding different types of materials with a diameter of 1.2 mm, and AC pulse welding or DC pulse welding was performed in a downward attitude at a current of 65 to 122 A, a voltage of 12.0 to 16.2 V, and a welding rate of 600 to 2000 mm/min. On the other hand, the laser welding was performed using a wire for welding different types of materials with diameters of 1.2 and 1.6 mm, and performed in a downward posture using fiber laser with a laser output of 2 to 4 kW and at a welding rate of 500 to 1000 mm/min. The best condition selected from the above range was used as the test condition actually adopted for the examples and the comparative examples. In addition, argon was used as a shield gas in each of the welding methods.

### (Arc Stability in MIG Welding)

To evaluate the arc stability in the MIG welding, the manner of arc transfer, the presence or absence of fluctuations in the arc length, and the concentration of the arc (whether or not the arc was biased to one of the base materials) were checked. The arc stability was evaluated as good (circular mark ∘) if there were no fluctuations in the arc length, the arc concentration was good, and a stable arc with spray transfer was obtained, and evaluated as passing (triangular mark Δ) or failing (cross mark ×), depending on the degree of deviation, if at least one of the above criteria was not met.

### (Molten State in Laser Welding)

To evaluate the molten state in the laser welding, the molten state of the wire for welding different types of materials under laser irradiation was observed with a high-speed camera. The molten state was evaluated as good (circular mark ∘) if the metal outer skin, the conductive core wire, and the flux were normally melted to form a molten pool, and evaluated as passing (triangular mark Δ) or failing (cross mark ×), depending on the degree of deviation, if any of the components was supplied unmelted to the molten pool or a stable molten pool was not formed.

### (Spatter Generation State)

To evaluate the spatter generation state, the spatter generation state during welding was visually observed, and the state of adhesion of spatter to the surface of the test piece after the welding was observed. The spatter generation state was evaluated as good (circular mark ∘) if little spatter was generated or adhered, passing (triangular mark Δ) if some spatter was generated but could be removed, and failing (cross mark ×) if much spatter was generated and adhered.

### (Bead Shape)

To evaluate the bead shape of the joint fabricated through the MIG welding or the laser welding, the bead shape on the surface of the joint was visually checked, and the sectional shape of the weld beads was observed using an optical microscope with a magnification of about 15 times. Samples for observation with the optical microscope were obtained by embedding a weld joint section cut out from the joint in a resin and buffing the section.

Preferably, the bead shape on the joint surface has a uniform bead width over the entire length, and has no lack of fusion or excessive penetration. For the sectional shape of the weld beads, preferably, the beads are spread on the surfaces of the aluminum alloy base material and the carbon steel or stainless steel plate, and have a large flank angle, the plates are joined to each other through brazing on the carbon steel or stainless steel side, and no excessive penetration or undercut is present on the aluminum alloy side. The bead shape was evaluated as very good (double circle mark ⊚) if all such conditions were met, failing (cross mark ×) if there was a lack of fusion or a significant defect in the other evaluation items, and passing (circular mark ∘ or triangular mark Δ) otherwise, depending on the degree of deviation.

### (Crack in Welded Metal Portion)

To evaluate a crack in the welded metal portion of the joint fabricated through the MIG welding or the laser welding, a weld joint section was observed using an optical microscope with a magnification of about 15 to 400 times to check the presence or absence of a crack in the welded metal portion, and was evaluated as good (circular mark ∘) if there was no crack in the weld metal portion, and failing (cross mark ×) if there was a crack in the welded metal portion.

Samples for observation with the optical microscope were obtained by embedding a weld joint section cut out from the joint in a resin and buffing the section, and checked in a non-etched state.

### (Tensile Test)

In the tensile test of the joints fabricated through the MIG welding or the laser welding, a tensile test piece with a width of 20 mm was taken orthogonally to the welding direction from the weld joints illustrated in FIGS. 7A to 7C, and a tensile load was applied to the aluminum alloy base material and the carbon steel or stainless steel plate using a Tensilon Universal Material Testing Instrument to measure the breaking load.

In the evaluation of the tensile test of the flare-weld joints and the stack-weld joints, the measured breaking load was determined as good (circular mark ∘) if the breaking load exceeded 4320 N, and failing (cross mark ×) if not, since the sectional area of the galvanized steel plate as a tensile test piece taken and processed from the flare-weld joints and the stack-weld joints was 16 mm², with reference to the tensile strength prescribed for a galvanized steel plate (JIS G 3313 SECCT) being 270 MPa or more.

In the evaluation of the tensile test of the butt-weld joints, meanwhile, the breaking load was determined as good (circular mark ∘) if the measured breaking load exceeded 4100 N, and failing (cross mark ×) if not, since the sectional area of the aluminum alloy as a tensile test piece taken and processed from the butt-weld joints was 20 mm², with reference to the tensile strength prescribed for an aluminum alloy (JIS H 4000 A6061P-T4) being 205 MPa or more.

(IMC Width)

In the evaluation of the intermetallic compound (IMC) of the joints fabricated through the MIG welding or the laser welding, a weld joint section was observed using an optical microscope with a magnification of about 400 times, and the thickness of the IMC layer was measured over the entire length of the interface on the carbon steel or stainless steel plate side. In the joint between aluminum or an aluminum alloy and a steel plate, a FeAl-based IMC layer generated at the interface on the steel plate side significantly lowers the joint strength. Therefore, the thickness of the layer is preferably suppressed to be small, and was evaluated as good (circular mark ∘) if the maximum width was 4 μm or less, and failing (cross mark ×) if the maximum width was 5 μm or more.

### (Test Results)

(Results: MIG Arc Stability/Laser Molten State/Spatter Generation State)

The effect of the present embodiment will be specifically described based on the test results indicated in Table 2 in FIG. 6. In Examples 1 to 7, 9, and 14 to 18, aluminum and an Al—Si alloy were used for the metal outer skin and the conductive core wire, respectively, which was such a combination that the solidus temperature of the conductive core wire was lower than that of the metal outer skin. In these examples, in the MIG welding, unstable behavior of liquid columns (molten columns) was suppressed even in a low-current range of 65 to 122 A, there were no fluctuations in the arc length, the arc concentration was good, and a stable arc with spray transfer was obtained. In Example 20, aluminum was used for the metal outer skin and the conductive core wire, and there was no difference between the respective solidus temperatures of the metal outer skin and the conductive core wire. Therefore, no effect was obtained in the MIG welding, and the concentration of the arc was slightly low.

In Examples 8, 10 to 13, and 19, meanwhile, the laser welding was performed with the flux filling rate meeting the prescribed range according to the present invention. In these examples, the metal outer skin, the conductive core wire, and the flux were normally melted to form a sound molten pool with high wettability.

In Comparative Examples 1 and 2, in contrast, the flux filling rate was high at 5.1 mass percent, and did not meet the prescribed range according to the present invention. In Comparative Example 1, the molten state was stable since the flux layer was formed from a dried coating layer, but the amount of spatter generated was large. In Comparative Example 2, meanwhile, the flux in a powder form was added, and therefore the molten state was poor, the amount of spatter generated was increased, and a sound molten pool was not formed.

### (Results: Bead Shape)

The evaluation results for the bead shape will be described. In Examples 1 to 7, 9, and 14 to 18, the MIG welding was performed, and the metal outer skin and the conductive core wire were in such a combination that the solidus temperature of the conductive core wire was lower than that of the metal outer skin. A good bead shape was obtained with the flux filling rate, the flux supply method, the type of the flux, and chemical components adequately adjusted. Among these examples, Examples 1 to 5, 7, 9, 14, 15, 17, and 18 had a flux filling rate in the range of 1.0 to 1.8%, and thus achieved an effect of increasing the arc stability and forming better beads. In Example 20, meanwhile, there was no solidus temperature difference between the metal outer skin and the conductive core wire, the arc stability in the MIG welding was slightly low, and therefore the bead width was slightly unstable.

In Examples 8, 10 to 13, and 19, meanwhile, the laser welding was performed, and a good bead shape was obtained with the flux filling rate, the flux supply method, the type of the flux, and chemical components adequately adjusted. Among these examples, Examples 11 to 13 and 19 had a flux filling rate in the range of 1.3 to 4.4%, and thus achieved an effect of stabilizing the molten state, improving the conformability, and forming better beads.

In contrast, Comparative Examples 3 to 5 provided a flux-cored wire such as those described in Patent Documents 1 and 2, not a wire with a multi-layer section [FIG. 2A or FIG. 4] according to the present invention, to which the flux in a powder form was added. In Comparative Examples 4 and 5, the flux filling rate was more than the range according to the present invention. Therefore, in Comparative Examples 4 and 5, the effect of the flux was so strong that an undercut was caused on the aluminum base material side. In Comparative Example 3, meanwhile, burn-through due to excessive penetration was caused substantially over the entire length on the aluminum alloy side in the flare joint, and the bead shape was failing.

In Comparative Examples 3 to 5 which used the conventional method, the metal-based fluoride with fine particles and low flowability could not be stably supplied. In Examples 1 to 20, however, the flux was supplied to the wire according to the present invention without non-uniform distribution at a flux filling rate in the range of 0.2 to 4.9% using the conductive core wire or the metal outer skin in which a flux coating layer of a flux paste had been formed in advance. Therefore, the effect of the flux was stably obtained, and a better bead shape was obtained.

### (Results: Crack in Welded Metal Portion)

The evaluation results for a crack in the welded metal portion will be described. In Examples 1 to 20, the flux filling rate, the flux supply method, and the type of the flux were in the range according to the present invention, and adequate amounts of Si, Cu, Mn, and Zn were contained with the remainder consisting of Al. Therefore, the matrix was not excessively cured because of a precipitate, and no crack was found in the welded metal.

### (Description: Breaking Load and IMC Width)

The results of the tensile test of the joints will be described. In Examples 1 to 13 and 16 to 20, the flux filling rate, the flux supply method, and the type of the flux were in the range according to the present invention, and an Al—Si—Cu-based chemical composition was used. The thickness of the IMC layer was suppressed to 4 μm or less because of the IMC generation suppression effect of Si, and a sufficient breaking load was obtained because of solid solution strengthening and precipitation strengthening of Cu.

In Example 14, the flux filling rate, the flux supplymethod, and the type of the flux were in the range according to the present invention, and an Al—Si—Mn-based chemical composition was used. The thickness of the IMC layer was suppressed to 4 μm or less because of the IMC generation suppression effect of Si, and a sufficient breaking load was obtained because of solid solution strengthening and precipitation strengthening of Mn.

In Example 15, the flux filling rate, the flux supplymethod, and the type of the flux were in the range according to the present invention, and an Al—Si—Zn-based chemical composition was used. The thickness of the IMC layer was suppressed to 4 μm because of the IMC generation suppression effect of Si and Zn, and a sufficient breaking load was obtained with the conformability and penetration shape of the beads improved because of the effect of Zn.

In Comparative Examples 1 and 2, the flux filling rate was 5.1 mass percent, which did not meet the prescribed range of the flux filling rate according to the present invention. Since the effect of the flux was excessive, a sufficient breaking load was not obtained with deep penetration caused and with burn-through caused on the aluminum alloy side in the laser welding. In addition, the amount of Fe contained in the welded metal was increased, and the thickness of the IMC layer at the interface on the carbon steel plate side was 5 μm or more.

In Comparative Examples 4 and 5, the flux filling rate was 5.9 mass percent and 6.7 mass percent, respectively, the flux in a powder form was added, and thus the flux filling rate and the flux supply method did not meet those according to the present invention. A sufficient breaking load was not obtained since an undercut was caused on the aluminum alloy side and a break was caused at the undercut portion in the MIG welding. In addition, the amount of Fe contained in the welded metal was increased, and the thickness of the IMC layer at the interface on the carbon steel and stainless steel plate side was 5 μm or more.

In Comparative Example 3, the flux in a powder form was added, and the flux supply method did not meet that according to the present invention. A sufficient breaking load was not obtained with burn-through due to excessive penetration caused substantially over the entire length on the aluminum alloy side in the flare joint.

In brazing, in general, flux is applied to the surface of a base material in advance, and the molten flux removes an oxidized film on the surface of the base material. After that, molten metal flows thereon to be joined at the interface. If brazing is performed using the flux-cored wire according to the related art described in Comparative Examples 3 to 5 in which the flux is disposed at the center portion of the wire, however, the flux is not easily melted, and the original effect of brazing cannot be easily obtained. With the wire with a multi-layer section according to Examples 1 to 20 of the present invention in which the flux is disposed close to the wire surface, in contrast, the flux starts being melted at an early timing, and the original effect of brazing can be easily obtained.

From the above, it has been found that the wire for welding different types of materials according to the present invention, which includes a flux layer constituted of a dried coating layer, achieves fabrication of a sound high-strength joint without a weld crack that provides high welding workability and a good bead shape in joining different materials, namely an Fe-based material and an Al-based material, to each other through MIG or laser welding.

### INDUSTRIAL APPLICABILITY

In the method according to the present invention, a coated conductive core wire material including a coating layer is formed by applying a flux paste to the surface of a conductive core wire material, or a coated metal outer skin material including a coating layer is formed by applying a flux paste to the inner surface of a metal outer skin material, thereafter a tubular metal outer skin material is formed, and a conductive core wire is disposed inside the metal outer skin material to form a wire for drawing. As a result of the coating layer being formed over the longitudinal direction and the circumferential direction of the wire in this manner, the flux is disposed as distributed over the longitudinal direction and the circumferential direction of the wire after a solvent in the coating layer is removed, even if the flux filling rate is low.

With the wire for welding different types of materials manufactured by the method according to the present invention, the flux layer is provided as a dried coating layer over the longitudinal direction and the circumferential direction even if the flux filling rate is low. Thus, the Fe-based material can be joined in a brazed state by preventing excessive penetration of the Al-based material with a stable arc even in a low-current range.

### DESCRIPTION OF REFERENCE NUMERALS

1 wire for welding different types of materials
3 metal outer skin
5 conductive core wire
7 dried coating layer

1. A method of manufacturing a wire for welding different types of materials of an Fe-based material and an Al-based material to each other,
the wire including a conductive core wire made of aluminum or an aluminum alloy and disposed in a tubular metal outer skin made of aluminum or an aluminum alloy,
the wire including a flux provided between the metal outer skin and the conductive core wire and having at least a function of removing an oxidized film from a surface of the material to be welded, and
the wire having a flux filling rate of 4.9 mass percent or less with respect to the total mass of the wire, the method comprising:
forming a coated conductive core wire material including a coating layer by applying a flux paste, which is obtained by kneading a material of the flux and a solvent with each other, to a surface of a conductive core wire material for forming the conductive core wire;
forming a wire for drawing by forming a tubular metal outer skin material for forming the tubular metal outer skin outside the coated conductive core wire material so that the coated conductive core wire material is centrally located in the tubular metal outer skin material; and
performing drawing work until the wire for drawing has a predetermined outside diameter.

2. The method of manufacturing a wire for welding different types of materials according to claim 1, wherein
the tubular metal outer skin material is formed after the coating layer is dried to such a degree that a part of the solvent remains.

3. A method of manufacturing a wire for welding different types of materials of an Fe-based material and an Al-based material to each other,
the wire including a conductive core wire made of aluminum or an aluminum alloy and disposed in a tubular metal outer skin made of aluminum or an aluminum alloy,
the wire including a flux provided between the metal outer skin and the conductive core wire and having at least a function of removing an oxidized film from a surface of a material to be welded, and
the wire having a flux filling rate of 4.9 mass percent or less with respect to the total mass of the wire, the method comprising:
forming a coated metal outer skin material including a coating layer by applying a flux paste, which is obtained by kneading a material of the flux and a solvent with each other, to an inner surface of a metal outer skin material having an arcuate cross-sectional shape taken orthogonally to a longitudinal direction thereof;
forming a wire for drawing by forming a tubular metal outer skin material outside a conductive core wire material for forming the conductive core wire by shaping the coated metal outer skin material with the conductive core wire material disposed inside the coated metal outer skin material; and
performing drawing work until the wire for drawing has a predetermined outside diameter.

4. The method of manufacturing a wire for welding different types of materials according to claim 3, wherein
the tubular metal outer skin material is formed after the coating layer is dried to such a degree that a part of the solvent remains.

5. A wire for welding different types of materials of a Fe-based material and an Al-based material to each other,
the wire including a conductive core wire made of aluminum or an aluminum alloy and disposed in a tubular metal outer skin made of aluminum or an aluminum alloy,
the wire including flux provided between the metal outer skin and the conductive core wire and having at least a function of removing an oxidized film from a surface of a material to be welded, and
the wire having a flux filling rate of 4.9 mass percent or less with respect to the total mass of the wire, wherein
the flux between the metal outer skin and the conductive core wire is provided as a dried coating layer.

6. The wire for welding different types of materials according to claim 5, wherein:
the Fe-based material is carbon steel or stainless steel; and
the conductive core wire is made of an aluminum alloy having a solidus temperature that is lower than that of the metal outer skin.

7. The wire for welding different types of materials according to claim 5, wherein:
the flux filling rate is 0.2 to 4.9 mass percent; and
the dried coating layer has a maximum thickness of 200 μm or less.

8. The wire for welding different types of materials according to claim 6, wherein:
the welding is MIG welding;
the wire for welding different types of materials has an outside diameter of 1.0 mm to 1.6 mm; and
the wire has the flux filling rate of 0.2 to 1.8 mass percent with respect to the total mass of the wire for welding different types of materials.

9. The wire for welding different types of materials according to claim 8, wherein
the wire has the flux filling rate of 1.0 to 1.8 mass percent with respect to the total mass of the wire for welding different types of materials.

10. The wire for welding different types of materials according to claim 7, wherein:
the welding is laser welding;
the wire for welding different types of materials has an outside diameter of 1.0 mm to 2.0 mm; and
the wire has the flux filling rate of 1.0 to 4.9 mass percent with respect to the total mass of the wire for welding different types of materials.

11. The wire for welding different types of materials according to claim 10, wherein
the wire has a flux filling rate of 1.3 to 4.4 mass percent with respect to the total mass of the wire for welding different types of materials.

12. The wire for welding different types of materials according to claim 5, wherein
the flux contains metal powder of an alloy element of molten metal.

13. The wire for welding different types of materials according to claim 5, wherein
the flux contains a KA1F-based metal fluoride as a main component, one or more kinds of metal fluorides such as CsAlF₄, KF, NaF, LiF, CeF, CsF, and AlF₃ added thereto, and one or more kinds of metal powder such as Al, Si, Cu, Zn, and Mn further added thereto.
